(19) United States
(12) Patent Application Publication
(10) Pub. No.: US 2005/0135629 A1
(43) Pub. Date: Jun. 23, 2005

(54) Apparatus and method for generating three-dimensional stereo sound in a mobile communication system

(75) Inventors: Jae-Hyun Kim, Seoul (KR); Sang-Ki Kang, Suwon-si (KR); Kyong-Joon Chun, Seoul (KR); Dong-Won Lee, Gwangmyeong-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/019,231

(22) Filed: Dec. 23, 2004

(30) Foreign Application Priority Data
Dec. 23, 2003 (KR) 2003-95807

(51) Int. Cl. H04R 5/00; H04R 5/02

(52) U.S. Cl. 381/17; 381/309

(57) ABSTRACT

An apparatus and method for generating a three dimensional (3D) stereo sound signal from a received audio signal in a mobile communication system are provided. In the 3D stereo sound generating apparatus, a low-frequency signal extraction portion extracts a low-frequency signal from a received audio signal, a spatiality generator generates a spatiality signal from the received audio signal, an output mode selector receives the spatiality signal and the low-frequency signal and selects an output mode for a 3D stereo sound signal, and an output portion outputs the 3D stereo sound signal to a predetermined output device according to the selected output mode.

### PRIORITY

This application claims the benefit under 35 U.S.C. § 119(a) to an application entitled “Apparatus and Method for Generating Three-Dimensional Stereo Sound in a Mobile Communication System” filed in the Korean Intellectual Property Office on Dec. 23, 2003 and assigned Serial No. 2003-95807, the entire contents of which are incorporated herein by reference.

### BACKGROUND OF THE INVENTION

1. Field of the Invention

The present invention relates generally to an apparatus and method for generating a sound signal in a mobile communication system. In particular, the present invention relates to an apparatus and method for generating a three-dimensional (3D) sound signal to create 3D sound effects.

2. Description of the Related Art

Three-dimensional sound is a sound signal with spatial information that enables a listener outside a sound source area to perceive the sound as originating from distinct spatial locations and different directions. As 3D sound effects become popular in various applications including multimedia, there is a need for developing a technology of recording and reproducing a sound signal that adds further realism (i.e. spatial information), and a need for controlling the three-dimensional sound effects freely and effectively. 3D sound is predominately provided on multiple channels (5.1 channels) in such fields as movies, TV programs, audio systems, and home theatre systems.

Although attempts have recently been made to create the 3D sound effects in handsets or Personal Digital Assistant (PDA) phones, the smallspeakers equipped in the phones have limitations in delivering a full low-frequency sound that can be achieved with home multimedia devices. When music, bell sounds, and sound effects for games are reproduced through two small speakers of a handset or a PDA phone, full sound effects are not available.

Hence, it is necessary to explore a method of creating improved 3D sound effects and minimize the degradation in voice call quality during a voice call in a handset or a PDA phone. The 3D sound effects are realized largely using three methods. One method uses a Sound Retrieval System (SRS). SRS delays the timing of certain portions of an audio signal so that different frequencies hit the ear of the listener at different times as the audio signal would sound in the original 3D sound field. The second method uses multichannel surround sound through a plurality of loudspeakers. The third method uses 2-channel 3D sound synthesis based on Head Related Transfer Function (HRTF), which involves human perception of direction. These 3D sound generation methods provide full 3D sound effects in applications to home multimedia devices.

However, the above 3D sound generation methods have limitations in creating full 3D effects due to limited speaker size in a 3-spreaker handset or PDA phone in which two of the speakers are used for 3D sound reproduction and the other for a call. The degradation in voice call quality during a call also arises from the limited speaker size.

The 3D sound reproduction technology for existing home multimedia devices provides full 3D sound effects. Due to simple low-frequency sound retrieval of a sound signal, the 3D sound reproduction technology is widely used. However, the low-frequency sound is not fully reproduced in a mobile communication system with handsets or PDA phones which utilize small speakers. Thus, the full 3D sound effects are not available to mobile communication system with handsets or PDA phones.

To achieve the 3D sound effects, that is, a distinct feeling of spatiality, convolution is required between the HRTF and a crosstalk canceling filter, resulting in increased low-frequency sound attenuation.

Moreover, difficult low-frequency sound reproduction due to the limited speaker size and the convolution-incurred low-frequency attenuation make it difficult to achieve the full 3D sound effects in handsets or PDA phones.

### SUMMARY OF THE INVENTION

An object of the present invention is to substantially solve at least the above problems and/or disadvantages and to provide at least the advantages below. Accordingly, an object of the present invention is to provide an apparatus and method for generating a 3D stereo sound signal to achieve full 3D sound effects and improve voice call quality during a call by minimizing low-frequency sound attenuation in a handset or PDA phone.

The above object is achieved by providing an apparatus and method for generating a 3D stereo sound signal from a received audio signal in a mobile communication system.

In the 3D stereo sound generating apparatus, a low-frequency signal extraction portion extracts a low-frequency signal from a received audio signal, a spatiality generator generates a spatiality signal from the received audio signal, an output mode selector receives the spatiality signal and the low-frequency signal and selects an output mode for a 3D stereo sound signal, and an output portion outputs the 3D stereo sound signal to a predetermined output device according to the selected output mode.

In the 3D stereo sound generating method, a low-frequency signal is extracted from an audio signal, upon receipt of the audio signal and adjusted. A spatiality signal is generated by applying an HRTF to the audio signal. The spatiality signal and the adjusted low-frequency signal are output to predetermined output devices.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a three dimensional (3D) stereo sound generating apparatus in a mobile communication system according to an embodiment of the present invention;

FIG. 2 is a detailed block diagram of a low-frequency signal extractor in the apparatus illustrated in FIG. 1; and

FIG. 3 is a flowchart illustrating an operation for generating 3D stereo sound according to the embodiment of the present invention.

### DETAILED DESCRIPTION OF THE PREFERRED EMBODIMENT

An embodiment of the present invention will now be described herein below with reference to the accompanying drawings. In the following description, well-known functions or constructions are not described in detail since they would obscure the invention in unnecessary detail.

The embodiment of the present invention provides a low-frequency sound reproducing algorithm in which the result of convolution between a head-related transfer function (HRTF) and a crosstalk canceling filter is transmitted to two stereo filters, for three dimensional (3D) sound effects, and the low-pass-filtered signal of an input sound signal is transmitted to a speaker for voice call (hereinafter, a voice call speaker). Also, the embodiment of the present invention provides an apparatus for achieving more realistic 3D sound effects using stereo speakers having a lower resonant frequency than a conventional speaker, and improving voice call quality during a call by minimizing low-frequency sound attenuation.

A 3D stereo sound generating apparatus for improving voice call quality in a mobile communication system according to an embodiment of the present invention will now be described. The term “a 3D stereo sound signal” is interchangeably used with “a spatiality signal” in the same sense of a signal offering 3D sound effects.

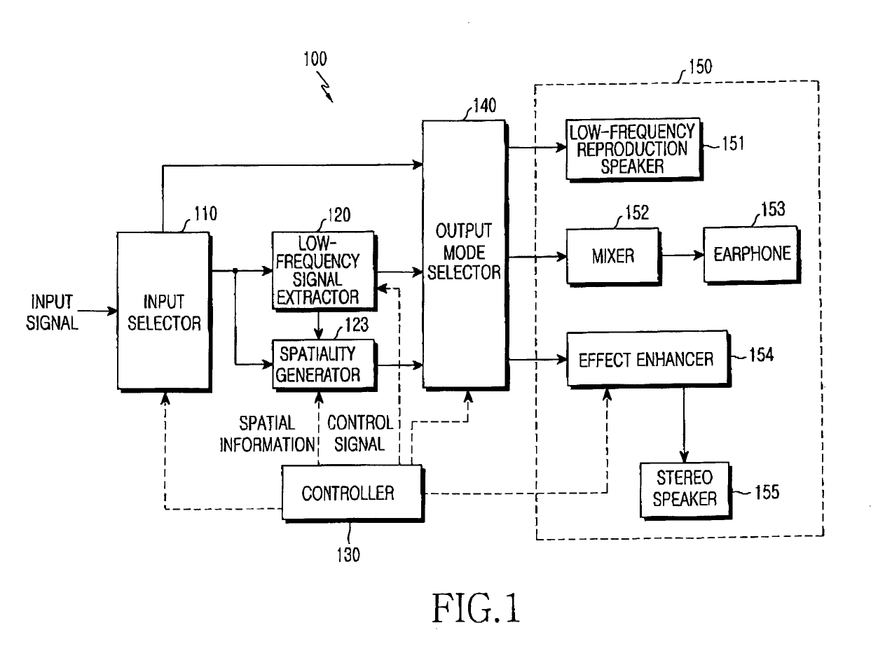

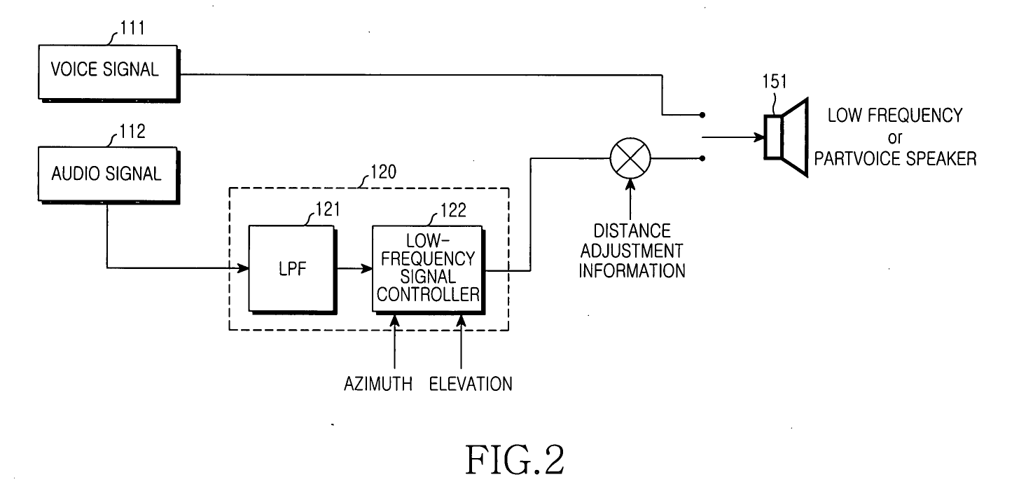

FIG. 1 is a block diagram of the 3D stereo sound generating apparatus in the mobile communication system according to the embodiment of the present invention and FIG. 2 is a detailed block diagram of a low-frequency signal extractor illustrated in FIG. 1.

Referring to FIG. 1, a 3D stereo sound generating apparatus 100 comprises an input selector 110 for determining the type of input signal such as a voice signal 111 or an audio signal 112 including music, for example, a low-frequency signal extractor 120 for extracting a low-frequency signal from the input signal, a spatiality generator 123 for generating a 3D stereo sound signal from the input signal, and a controller 130 for controlling the 3D sound generation. The 3D stereo sound generating apparatus 100 is further provided with an output mode selector 140 for selecting an output mode according to the generation of the 3D stereo sound signal, and an output portion 150 for outputting a final signal.

The input selector 110 determines the type of input signal. If the input signal is a voice signal for a call, the input selector 110 provides the input signal directly to the output mode selector 140 without transmitting to the low-frequency signal extractor 120 and the spatiality generator 123. If the input signal is an audio signal, the input selector 110 transmits it to the low-frequency signal extractor 120 and the spatiality generator 123.

Referring to FIG. 2, the low-frequency signal extractor 120 includes a low pass filter (LPF) 121. The LPF 121 extracts a low-frequency signal from an input signal to compensate for the loss of the low-frequency signal that takes place during reproduction of the input signal. The low-frequency signal compensation prevents the attenuation of the low-frequency component of the input signal that may be caused by HRTF convolution for creating 3D sound and crosstalk cancellation filtering for reproducing the spatiality signal in stereo speakers. The low-frequency signal extractor 120 also includes a low-frequency signal controller 122. The low-frequency signal controller 122 adjusts the time delay or amplitude of the extracted low-frequency signal to appropriately combine it with an audio output with spatial information for 3D sound effects.

The spatiality generator 123 generates a spatiality stereo audio signal offering desired 3D effects using the HRTF for the audio signal received from the input selector 110. The HRTF is calculated by linear interpolation in order to overcome the limited memory capacity of a mobile device. That is, the spatiality generator 123 generates left and right HRTFs by linear interpolation of the HRTF using spatial information including azimuth and elevation and applies distance adjustment information to the left and right HRTFs.

Meanwhile, the controller 130 transmits necessary information to each component and provides overall control to the 3D sound generation. The controller 130 provides direction information and motion information as spatial information to the spatiality generator 123 for desired sound localization. The controller 130 also transmits to the output mode selector 140 a control signal indicating the type of input signal and an output mode to be used.

The output mode selector 140 selects an output mode according to the input signal. Upon receipt of a voice signal directly from the input selector 110, the output mode selector 140 selects a voice call mode and outputs the input signal without any processing to the output portion 150. On the other hand, upon receipt of a low-frequency signal and a spatiality signal from the low-frequency signal extractor 120 and the spatiality generator 123, the output mode selector 140 selects a hybrid mode or a stereo mode and outputs the signals to the output portion 150.

The output portion 150 has a low-frequency reproduction speaker 151 for outputting a voice signal and the low-frequency signal of an audio signal, a mixer 152 for mixing the 3D sound with the low-frequency signal, an earphone 153 for outputting the mixed signal, an effect enhancer 154 for enhancing 3D sound effects, and stereo speakers 155 for outputting a stereo signal.

The low-frequency reproduction speaker 151 outputs the voice signal received from the output mode selector 140 in the voice call mode and reproduces more low frequency sounds than a conventional speaker during a voice call, thereby improving voice call quality and personal voice quality. Also, the low-frequency reproduction speaker 151 outputs the low-frequency component of the original audio signal to minimize low-frequency attenuation caused by the HRTF convolution and crosstalk cancellation filtering for 3D sound effects.

In the hybrid mode, the mixer 152 mixes the low-frequency signal adjusted by the low-frequency signal controller 122 and the stereo audio signal generated by the spatiality generator 123 as received from the output mode selector 140 and outputs the resultant audio signal through the earphone 153.

In the stereo mode, the effect enhancer 154 cancels crosstalk from the low-frequency signal received from the output mode selector 140 and virtually localizes sounds to the left and to the right as if left and right speakers were spaced widely with respect to the listener, to thereby enhance the 3D sound effects in the mobile device. If the 3D sound is reproduced simply though the speakers, the output signals of the left and right speakers are combined, nullifying the 3D sound effects. Hence, the listener cannot enjoy the 3D sound effects. That's why the effect enhancer 154 performs crosstalk cancellation filtering, to thereby acquire the original 3D sound effects.

A method of reproducing 3D sound through low-frequency compensation of a stereo signal in the thus-configured 3D sound generating system will be described below.

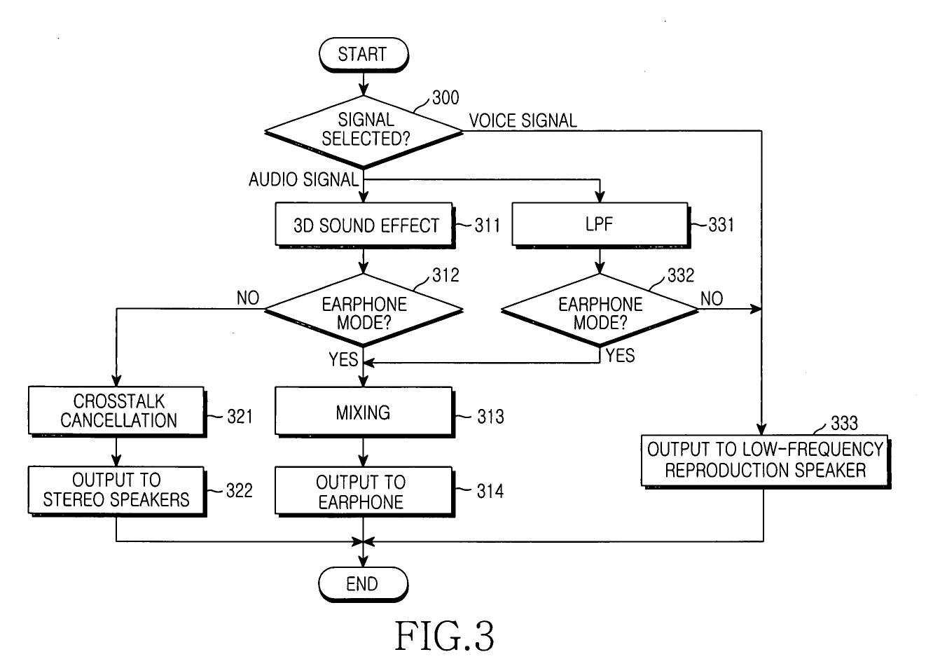

FIG. 3 is a flowchart illustrating an operation for generating 3D stereo sound according to the embodiment of the present invention.

Referring to FIG. 3, the 3D stereo sound generating apparatus 100 selects an input signal from the input selector 110 in step 300. If the input selector 110 selects a voice signal, the 3D stereo sound generating apparatus 100 outputs the voice signal to the low-frequency reproduction speaker 151 in step 333. That is, the voice output of the input selector 110 is provided to the mode selection 140. Thus, the output mode selector 140 switches to a voice signal path by a switch (not shown) and selects the voice call mode. The output mode selector 140 then outputs the voice signal to the low-frequency reproduction speaker 151.

On the other hand, if the input selector 110 selects an audio signal in step 300, the 3D stereo sound generating apparatus 100 provides the audio signal to the spatiality generator 123 in step 311. The spatiality generator 123 computes convolution of the left and right HRTFs based on distance adjustment information received from the controller 130 in order to provide directionality and spatiality to the input signal. In this process, the spatiality generator 123 outputs the left and right HRTFs by linear interpolation because of a large amount of HRTF data to be stored in a memory. At the same time, the 3D stereo sound generating apparatus 100 provides the audio signal to the low-frequency signal extractor 120 in step 331. The low-frequency signal extractor 120 extracts a low-frequency signal by low pass filtering and controls the reproduction degree of the low-frequency signal under the control of the controller 130.

In steps 312 and 332, the 3D stereo sound generating apparatus 100 selects a corresponding output mode through the output mode selector 140. If the output mode is an earphone mode as the spatiality signal is provided to the output mode selector 140 in step 312, the 3D stereo sound generating apparatus 100 mixes signals in the mixer 152 in step 313 and outputs the mixed signal through the earphone 153 having left and right pieces in step 314.

If the mode selection 140 selects a speaker mode, the 3D stereo sound generating apparatus 100 cancels crosstalk from the stereo audio signal in the effect enhancer 154 and virtually localizes sounds to the left and to the right based on distance and direction information received from the controller 130 as if the left and right speakers were apart widely from each other in step 321. In step 322, the 3D stereo sound generating apparatus 100 outputs the crosstalk-cancelled stereo audio signal to the left and right stereo speakers 155.

If the output mode selector 140 selects the earphone mode as it receives the extracted low-frequency signal in step 332, the 3D stereo sound generating apparatus 100 goes to step 313. If it selects the speaker mode in step 332, the 3D stereo sound generating apparatus 100 provides the low-frequency signal to the low-frequency reproduction speaker 151 in step 333.

As described above, the embodiment of the present invention outputs a 3D stereo signal processed for 3D sound effects through two stereo speakers, while controlling the amplitude of a low-pass-filtered low-frequency signal of an input signal and outputting it through a low-frequency reproduction speaker. Therefore, full 3D sound effects are created and the degradation of voice call quality is minimized in a mobile communication system.

Furthermore, the use of stereo speakers having a lower resonant frequency than a conventional voice call speaker reduces low-frequency signal attenuation and improves the voice call quality.

While the invention has been shown and described with reference to a certain embodiment thereof, it should be understood by those skilled in the art that various changes in form and details may be made therein without departing from the spirit and scope of the invention as defined by the appended claims.

1. An apparatus for generating a three-dimensional (3D) stereo sound signal from a received audio signal in a mobile communication system, comprising:
a low-frequency signal extraction portion for extracting a low-frequency signal from a received audio signal;
a spatiality generator for generating a spatiality signal from the received audio signal;
an output mode selector for receiving the spatiality signal and the low-frequency signal and selecting an output mode for a 3D stereo sound signal; and
an output portion for outputting the 3D stereo sound signal to a predetermined output device according to the selected output mode.

2. The apparatus of claim 1, wherein the low-frequency signal extraction portion comprises:
a low-frequency signal extractor for extracting the low-frequency signal from the received audio signal; and
a low-frequency signal controller for controlling the extracted low-frequency signal by a received control signal.

3. The apparatus of claim 1, wherein the spatiality generator generates the spatiality signal by generating left and right head-related transfer functions (HRTFs) through interpolation of an HRTF based on a received azimuth and elevation.

4. The apparatus of claim 1, further comprising a controller for providing spatial information to the spatiality generator so that the spatiality generator generates the spatiality signal, and controlling the output mode selector to select the output mode.

5. The apparatus of claim 4, wherein the controller provides the spatial information to the spatiality generator and the control signal to the low-frequency signal extraction portion.

6. The apparatus of claim 4, wherein the output portion comprises:
a low-frequency reproduction speaker for outputting an input voice signal and the low-frequency signal received from the low-frequency signal extraction portion;
a mixer for mixing the low-frequency signal and the spatiality signal;
an earphone for outputting the mixed signal;
an effect enhancer for canceling crosstalk from the spatiality signal received from the spatiality generator, and virtually localizing the sounds of the spatiality signal, thereby generating a desired stereo signal; and
a stereo speaker for outputting the desired stereo signal.

7. The apparatus of claim 1, wherein the apparatus comprises a mobile receiver.

8. The apparatus of claim 7, wherein the mobile receiver includes a Personal Digital Assistant (PDA).

9. The apparatus of claim 6, wherein the stereo speaker comprises a dual speaker arrangement.

10. A method of generating a three-dimensional (3D) stereo sound signal with spatial information in a mobile communication system, comprising the steps of:
extracting a low-frequency signal from an audio signal, upon receipt of the audio signal, and controlling the extracted low-frequency signal;
generating a spatiality signal by applying a head-related transfer function (HRTF) to the audio signal; and
receiving the spatiality signal and the controlled low-frequency signal and outputting the spatiality signal and the controlled low-frequency signal to predetermined output devices.

11. The method of claim 10, further comprising the step of providing spatiality information and a control signal to generate the spatiality signal.

12. The method of claim 10, wherein the spatiality signal generating step comprises the step of generating the spatiality signal by generating left and right HRTFs through interpolation of the HRTF based on a received azimuth and elevation.

13. The method of claim 10, wherein the signal outputting step comprises the steps of:
receiving the low-frequency signal and the spatiality signal, mixing the low-frequency signal and the spatiality signal, and outputting the mixed signal, when the 3D stereo sound signal is output to an earphone; and
receiving the spatiality signal, canceling crosstalk from the spatiality signal, virtually localizing the sounds of the spatiality signal to the left and to the right, and thus outputting a desired stereo signal, when the 3D stereo sound signal is output to a stereo speaker.

14. The method of claim 10, further comprising the step of, upon receipt of a voice signal, simply outputting the voice signal to a low-frequency reproduction speaker.

15. The method of claim 10, further comprising:
providing direction information and motion information as spatial information.

16. The method of claim 10, wherein the audio signal comprises a music signal.

17. The method of claim 12, wherein the interpolation comprises linear interpolation.

18. The method of claim 12, further comprising:
providing convolution of the left and right HRTFs based on distance adjustment information. 19. The method of claim 13, wherein the stereo speaker comprises a dual speaker arrangement.
